(19) United States
(12) Patent Application Publication
(10) Pub. No.: US 2025/0200661 A1
(43) Pub. Date: Jun. 19, 2025

(54) SIMULATION-BASED MODELING SYSTEM

(71) Applicant: PwC Product Sales LLC, New York, NY (US)

(72) Inventors: Anand Srinivasa RAO, Lexington, MA (US); Vamse Kumar SUBBIAH, Chicago, IL (US); Joseph David VOYLES, Louisville, KY (US); Manaswi VELIGATLA, Victoria (AU); Mahesh ADIMULAM, Vijayawada (IN)

(73) Assignee: PwC Product Sales LLC, New York, NY (US)

(21) Appl. No.: 18/538,537

(22) Filed: Dec. 13, 2023

(51) Int. Cl. G06Q 40/06

(52) U.S. Cl. CPC G06Q 40/06

(57) ABSTRACT

Disclosed herein are systems and methods for determining retirement readiness of an individual and/or household. The method comprises receiving input data comprising characteristic data of an individual; executing a simulation based on the received input data; displaying, based on a response of the simulation to the received input data, an initial retirement readiness of the individual; receiving a user input comprising a selection of one or more scenarios based on the displayed initial retirement readiness; executing the simulation based at least in part on the one or more selected scenarios; and displaying, based on a response of the simulation to the one or more selected scenarios, an updated retirement readiness of the individual.

### FIELD

This disclosure relates generally to simulation models, and more specifically to simulation-based modeling frameworks for projecting retirement readiness.

### BACKGROUND

Computer simulations can include agent-based models that stochastically simulate the actions and interactions of autonomous agents to understand the dynamic behavior of the overall system and what governs its outcomes. Agents can represent individuals or collective entities (e.g., organizations, groups, households, etc.) that are assigned attributes to define the behavior of the system. An agent within the simulation may interact with other agents based on similar attributes in order to model the complex system to assess the impact of interaction. Environmental variables that may affect agents in the simulation over time may be defined to observe the outcome of the system of agents based on interactions and the variables. Agent-based models have been applied to recreate and assess the impact of complex phenomena in a variety of domains in real world scenarios, such as analyzing the spread of disease, stock market risks, consumer behaviors, understanding the human body, and traffic simulations.

### SUMMARY

Simulation models may include agent-based models that use agents with individually defined behaviors and apply environmental variables to understand the outcome of a system of agents. Disclosed herein are simulation-based modeling systems that may be used, for example, to simulate financial portfolios of individuals based on characteristic data of respective individuals, socioeconomic/economic variables applied to the simulation, and scenarios represented by interactions between agents in the simulation. For example, the disclosed simulation-based models may be applied to determine the retirement readiness of an individual and/or household.

Known financial planning calculators may be limited to making predictions based on static financial calculations using machine learning or similar techniques with a limited number of user inputs. The calculators may completely rule out or make generic assumptions failing to provide personalized experience, for example, on life expectancy, social security benefits, inflation, investment growth rate, and/or income growth rate that may not accurately or comprehensively predict the individual's unique financial portfolio at least because the calculators may be unable to predict changes in one or more variables. Moreover, calculators such as financial planning calculators, retirement calculators etc., may be unable to model outcomes for unforeseen systemic and/or personal life events (e.g., pandemics, unemployment, etc.).

Accordingly, there is a need for improved simulation-based modeling systems that may be used, for example, to simulate financial portfolios of individuals based on generic and specific characteristic data of respective individuals, socioeconomic/economic variables applied to the simulation, and interactions between agents in the simulation. Furthermore, there is a need for such systems that are configured to be able to model outcomes for unforeseen systemic and/or personal life events. The systems and methods discussed herein may address one or more of the above-identified needs.

By applying a simulation model using a large population, systems disclosed herein may more accurately predict, for example, the financial portfolio (e.g., retirement readiness) of an individual/household. For example, the simulation model may consider user inputs describing current and/or historic characteristic data (e.g., socioeconomic, household, and/or financial data) of an individual, as well as similar characteristic data describing a population. Based on the input data, the system may be configured to execute a simulation to produce a projected financial portfolio (e.g., retirement readiness) of the individual/household. In some embodiments, the user may apply one or more scenarios to the simulation to predict the response of the individual to the scenario that may otherwise have been unforeseen in the simulation. An updated retirement readiness output may be produced by the simulation based on the agents' response to the scenarios applied in the simulation, thus providing a multi-faceted, comprehensive projection of the individual and/or household's retirement readiness.

In some instances, the simulation model disclosed herein may be extended to multiple sectors within financial services, including but not limited to retail banking, payments, capital markets, wealth management, institutional and retail asset management. Moreover, the model can be targeted beyond individual/household (e.g., consumer) behavior to advisor, broker-dealer, employer or plan-sponsor, product manufacturer, and regulatory authority behaviors. The repertoire of products it addresses can once again be extended from life insurance, annuities, retirement plans, to deposit, savings, investment, payment, mutual funds, long-term care, and group benefit products.

In some embodiments, a simulation system for determining retirement readiness is provided, comprising: one or more processors; memory; and one or more programs stored on the memory that when executed by the one or more processors cause the one or more processors to: receive input data comprising characteristic data of an individual; execute a simulation based on the received input data; display, based on a response of the simulation to the received input data, an initial retirement readiness of the individual; receive a user input comprising a selection of one or more scenarios based on the displayed initial retirement readiness; execute the simulation based at least in part on the one or more selected scenarios; and display, based on a response of the simulation to the one or more selected scenarios, an updated retirement readiness of the individual.

In some embodiments, the initial retirement readiness and the updated retirement readiness of the individual are displayed in at least one visualization.

In some embodiments, the initial retirement readiness is displayed in a first visualization, and the updated retirement readiness is displayed in a second visualization.

In some embodiments, the visualization of the updated retirement readiness comprises one or more graphical representations corresponding to the one or more selected scenarios.

In some embodiments, a graphical representation in the visualization of the updated retirement readiness corresponds to a combination of selected scenarios.

In some embodiments, the one or more graphical representations comprise a plurality of data points corresponding to retirement readiness values over a duration of time.

In some embodiments, the one or more programs cause the one or more processors to receive additional input data comprising characteristic data of the individual based on the selection of one or more scenarios.

In some embodiments, the simulation is executed based on the one or more selected scenarios and the additional input data.

In some embodiments, the one or more programs cause the one or more processors to display a plurality of scenario options with the initial retirement readiness of the individual.

In some embodiments, one or more of the displayed scenario options are based at least in part on actions of a user of the simulation system.

In some embodiments, one or more of the displayed scenario options are personal scenarios based at least in part on the characteristic data of the individual.

In some embodiments, the simulation comprises a plurality of agents generated based on characteristic data of a population.

In some embodiments, the one or more programs cause the one or more processors to display one or more systemic scenario options based at least in part on the characteristic data of the population.

In some embodiments, the one or more programs cause the one or more processors to display a recommendation based on the updated retirement readiness of the individual.

In some embodiments, the characteristic data of the individual comprises one or more of socioeconomic data, household data, and financial data.

In some embodiments, executing the simulation based at least in part on the one or more selected scenarios comprises running a plurality of iterations of the simulation.

In some embodiments, executing the simulation based at least in part on the one or more selected scenarios comprises analyzing potential outcomes of the plurality of iterations to determine a retirement readiness output.

In some embodiments, the retirement readiness output corresponds to the updated retirement readiness of the individual at a given time.

In some embodiments, a method for determining retirement readiness is provided, the method comprising: receiving input data comprising characteristic data of an individual; executing a simulation based on the received input data; displaying, based on a response of the simulation to the received input data, an initial retirement readiness of the individual; receiving a user input comprising a selection of one or more scenarios based on the displayed initial retirement readiness; executing the simulation based at least in part on the one or more selected scenarios; and displaying, based on a response of the simulation to the one or more selected scenarios, an updated retirement readiness of the individual.

In some embodiments, a non-transitory computer-readable storage medium storing one or more programs for determining retirement readiness is provided, the programs for execution by one or more processors of an electronic device that when executed by the device, cause the device to: receive input data comprising characteristic data of an individual; execute a simulation based on the received input data; display, based on a response of the simulation to the received input data, an initial retirement readiness of the individual; receive a user input comprising a selection of one or more scenarios based on the displayed initial retirement readiness; execute the simulation based at least in part on the one or more selected scenarios; and display, based on a response of the simulation to the one or more selected scenarios, an updated retirement readiness of the individual.

### BRIEF DESCRIPTION OF FIGURES

The invention will now be described, by way of example only, with reference to the accompanying drawings, in which:

FIG. 1 shows a process diagram for determining retirement readiness using a simulation model, in accordance with some embodiments.

FIGS. 2A-2G show example outputs of the simulation-based modeling system, in accordance with some embodiments.

FIG. 3 shows a method for determining retirement readiness, in accordance with some embodiments.

FIG. 4 shows a simulation-based modeling system, in accordance with some embodiments.

FIG. 5 shows a device for implementing a simulation-based modeling system, in accordance with some embodiments.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

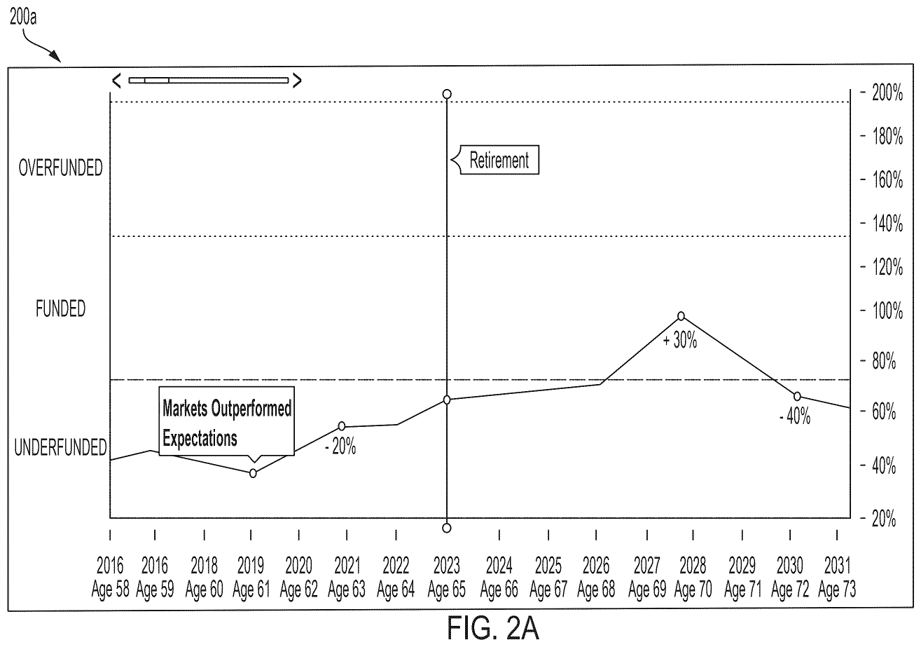

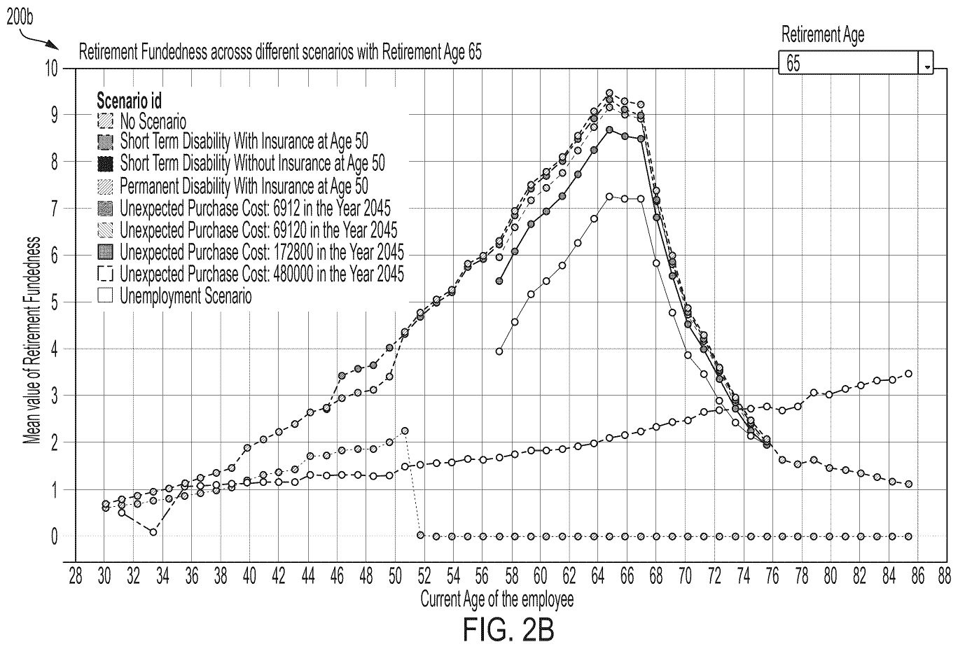

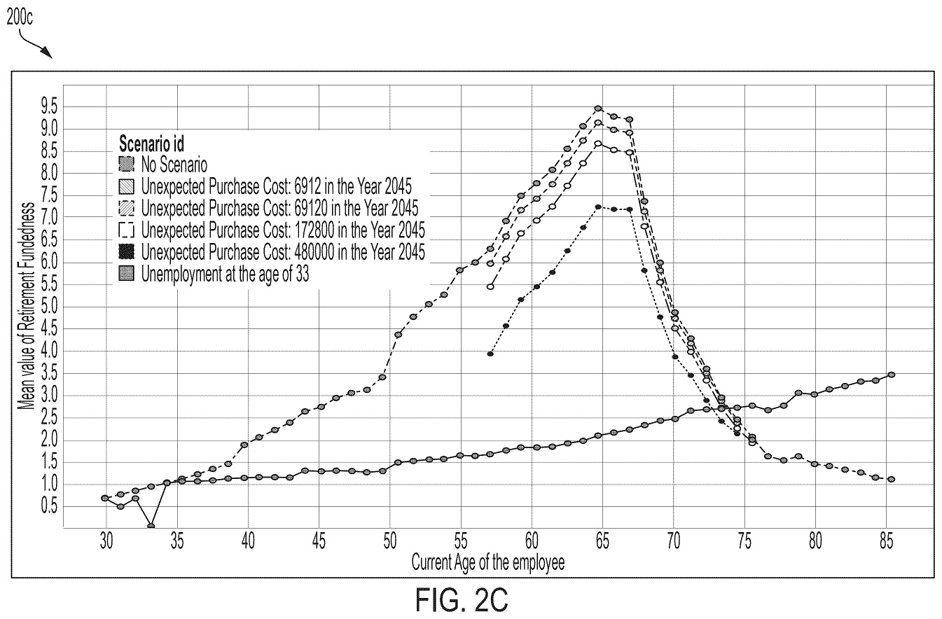

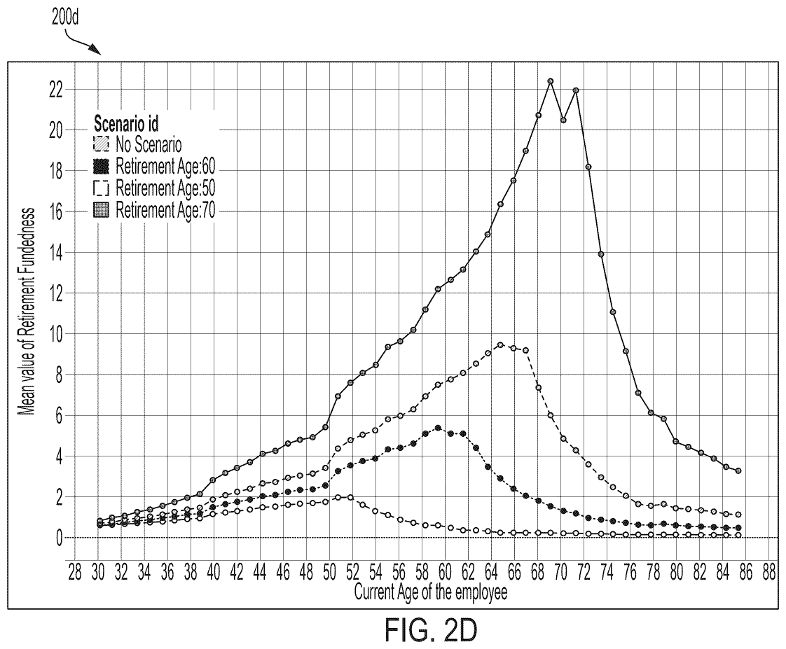

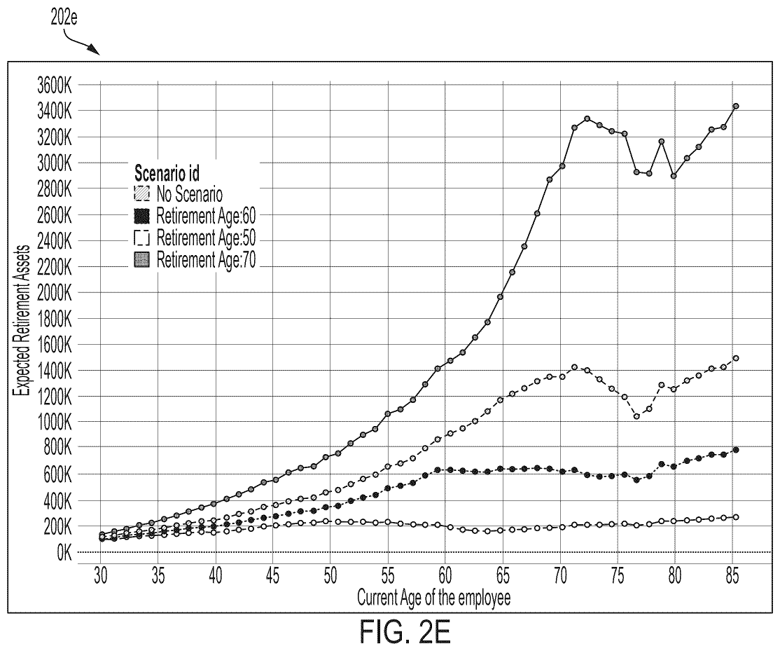

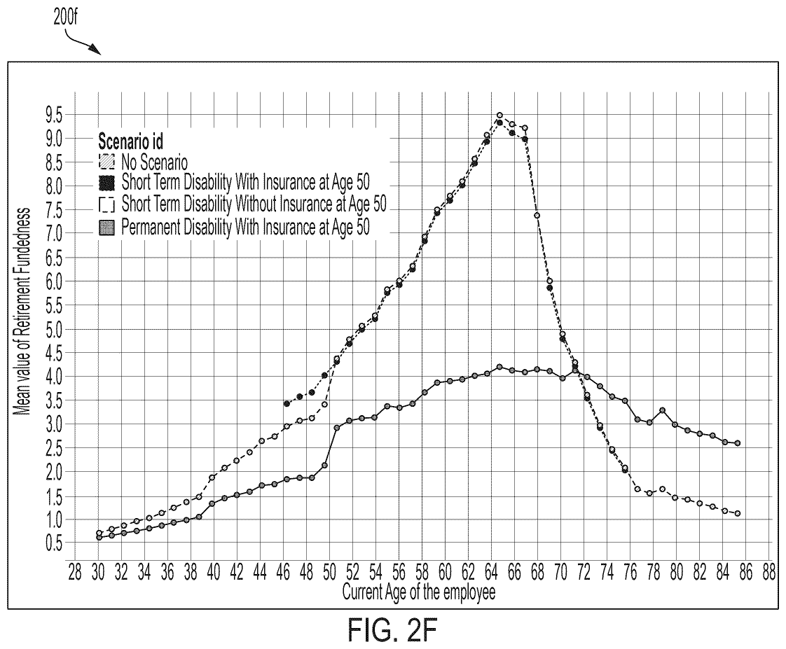

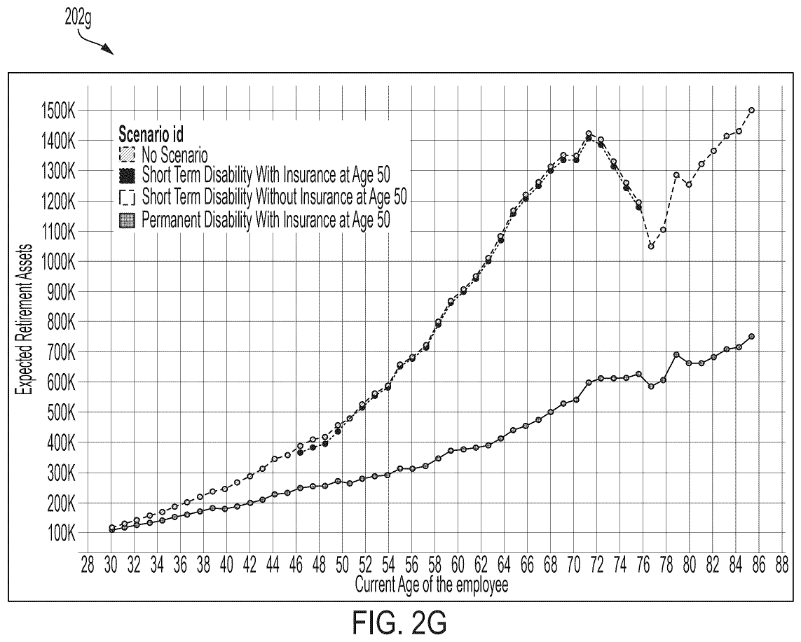

Disclosed herein are methods and systems integrated in a microservice architecture for projecting financial information (e.g., a financial portfolio, retirement readiness, etc.) of an individual and/or household. The system may comprise a simulation-based model configured to generate agents and observe the response of agents to socioeconomic and/or economic variables. For example, the system may be configured to receive input data from a user, the data comprising characteristics of an individual (e.g., financial data, household data, socioeconomic data, etc.). Furthermore, the dynamics of the system may be tuned by accessing/retrieving one or more datasets representing/comprising characteristic data of a population. Based on the input data and population data, the system may be configured to generate agents (e.g., digital twins) with individually defined attributes. The user may apply a plurality of socioeconomic and/or economic variables to the system and may execute the simulation with the variables and agents to project the financial portfolio of an individual and/or household. Additionally, the system may be configured to receive a selection of one or more scenarios (e.g., life events, such as an emergency expenditure) configured to affect one or more agents in the simulation. Based on the selected scenarios, the simulation may be executed again to determine the effect of the scenarios on the retirement readiness of the individual and/or household at a particular time period. The system may be configured to display an initial retirement readiness output (e.g., without applying scenarios) and updated retirement readiness output (e.g., with one or more selected scenarios). For example, the system may display retirement readiness of the individual/household a visualization comprising one or more graphical representations (e.g., plots), as will be described in greater detail below with respect to FIG. 2A-2G.

The simulation system for determining retirement readiness may be scalable, at least because the framework may comprise a plurality of individually deployable microservices for providing services of the simulation engine simultaneously. Additionally, the microservices embodied in the simulation system may allow for packaging code/services, parallel processing, efficient central processing unit (CPU) memory usage, seamless integration, and computational elasticity (e.g., in comparison at least to monolithic architectures). By optimizing the simulation-based modeling system using microservices, the model may be able to simulate and process millions of agents simultaneously and may be consumed by a large number (e.g., thousands) users at once with a high degree of agility and fast delivery to the end user.

### Process for Determining Retirement Readiness

The financial portfolio of an individual and/or household (e.g., two or more individuals sharing income and/or expenses), which may include retirement readiness, may be projected using a simulation model configured to receive input data, receive user inputs (e.g., user financial standings/behavior), and consider economic and/or socioeconomic factors defined by the dynamics of the system.

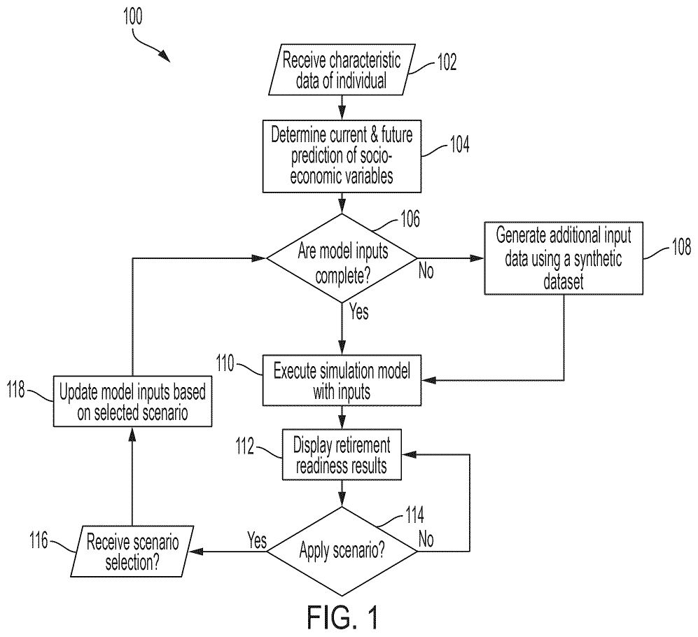

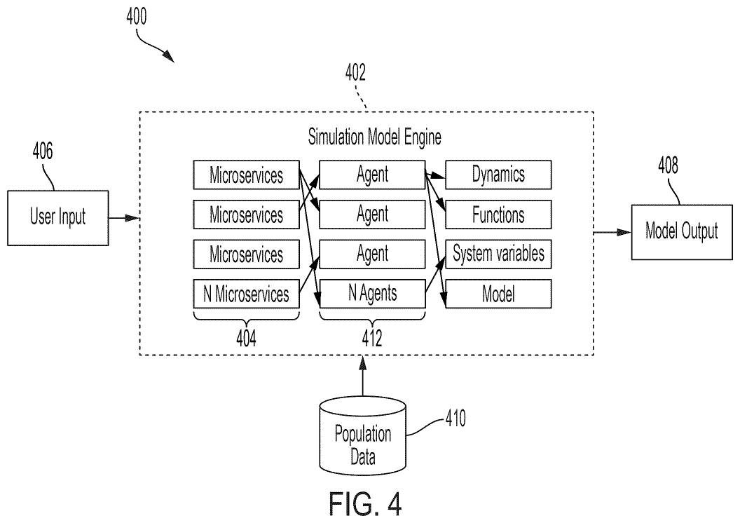

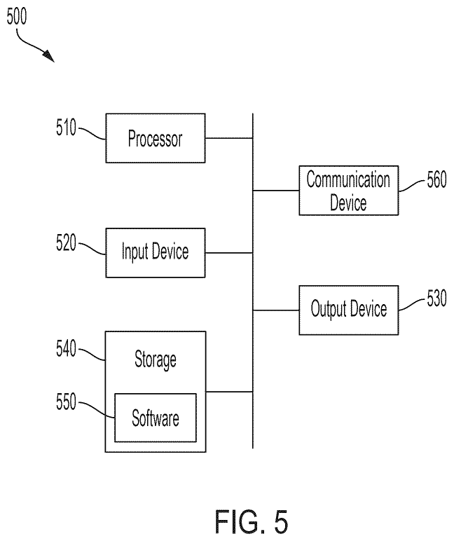

FIG. 1 shows a process diagram 100 for determining retirement readiness of an individual and/or household, in accordance with some embodiments. Process 100 may be implemented by a computerized system, such as systems 400 and/or 500 described below with respect to FIG. 4 and FIG. 5, respectively.

At step 102, the system may receive input data describing an individual. In some embodiments, the input data may be provided by a user via a user interface associated with a client device. In some embodiments, the user may be the individual described by the data. For example, a user may engage with the system via a personal computing device (e.g., mobile device, desktop, tablet, etc.) to provide user inputs to the system describing themselves. In some embodiments, the user may be different from the individual described by the user input data. For example, a financial advisor, financial planner, guardian, partner, etc. may provide input data describing an individual on behalf of the individual to the system.

In some embodiments, the input data may comprise characteristic data describing an individual. Characteristic data may include data describing characteristics (e.g., traits) of the individual. In some embodiments, data may include historic and/or current socioeconomic data, household data, basic demographic data, and/or financial data. For example, socioeconomic data may include historic and/or current annual base income(s), historic and/or current employment/occupation status, level of education, etc. Financial data may comprise data related to financial assets, liabilities, and retirement savings. For example, financial data may include historic and/or current mortgage, savings, debt, retirement funds (e.g., 401(k), individual retirement account (IRA), etc.), loans (e.g., auto loans, student loans, etc.), etc. Household data may include marital status, and if applicable, spouse information (e.g., socioeconomic and/or financial data of a spouse/partner) and dependent information (e.g., number of dependents, age of dependents, etc.). Demographic data may include age and gender. In some embodiments, the system may be configured to receive individual characteristic data describing one or more individuals of the household (e.g., socioeconomic and/or financial data of each individual), and the data may be aggregated for inputting to the simulation.

In some embodiments, the input data may comprise a target retirement age or range of ages of the individual and/or individuals in the household. In some embodiments, the system may be configured to execute the simulation with a default retirement age in the instance a retirement age is not provided by the user (e.g., 65 years of age).

In some embodiments, the data provided to the system may be based on one or more prompts displayed to the user. For example, the user may be prompted to complete one or more required and/or suggested fields requesting data (e.g., the characteristic data described above) on a graphical user interface. For example, the user may manually input data and/or upload data to the system. In some embodiments, the user may complete an authentication to allow the system to access one or more financial accounts associated with the individual to retrieve data. For example, the user may be prompted to select a financial institution comprising financial data of the individual and may sign into an account associated with the financial institution to allow the system to access financial data. In some embodiments, the system described herein may be deployed by a financial institution comprising financial data of the individual, and thus may access the financial data without requiring additional authentication by the user.

At step 104, the system may determine current and future socioeconomic variables and economic variables for the agent-based simulation model. For example, the system may comprise a predetermined set of economic and socioeconomic variables and may select variables to be applied in the simulation (e.g., based on characteristic data of the individual, household, population, etc.). In some embodiments, the socioeconomic and/or economic variables may be parameterized, for example, based on current and/or historic data related to the variables. For example, the likelihood (e.g., probability) of a given socioeconomic and/or economic variable affecting individuals/households in the simulation may be determined. In some embodiments, the extent to which a socioeconomic and/or economic variable may affect an individual/household in the simulation may be determined based on the characteristic data of the individual and the population data (described in greater detail below).

In some embodiments, socioeconomic variables may include marriage, divorce, having children, changing employment, buying a house, getting a higher education, etc. Economic variables may include, for example, inflation rate, interest rate, gross domestic product (GDP), stock market impacts, etc. As mentioned above, the system may be configured to determine a probability of a particular variable occurring in the individual's lifetime in the simulation. For example, the system may be configured to predict if and/or when an individual will purchase a home, e.g., in the instance, they are currently renting based on the number of years the individual has been renting and the current financial portfolio of the individual.

At step 106, the system may confirm prior to executing the agent-based simulation model whether the model inputs are sufficient (e.g., complete) for projecting retirement readiness of the individual. In some embodiments, as shown in FIG. 4, model inputs may include user inputs as well as population data. In some embodiments, population data may comprise household data, socioeconomic data, and/or financial data describing a population (e.g., individuals and/or households in a region, city, county, state, nation, etc.). In some embodiments, the data may be retrieved from one or more publicly accessible databases. In some embodiments, the population data may comprise one or more proprietary datasets (e.g., survey data, benchmark data, etc.). In some embodiments, the population data comprises a combination of proprietary and public data. The data may additionally or alternatively comprise partnership datasets and/or third-party purchased datasets.

The model may utilize existing custom/public datasets that can be influenced by gender, such as mortality data and life expectancy data. In some embodiments, the model may additionally or alternatively consider age-dependent public data such as retirement probability and/or marriage rates. The model may additionally or alternatively consider public datasets comprising fixed expense distribution data.

The model may be calibrated, for example, based on changes in employment, savings and/or expenses, income, retirement contributions, health status, etc. For example, unemployment, re-employment, and starting/stopping job searches may be considered in the model. In another example, a wage growth rate, a switch from a full-time to a part-time job (or vice versa) may affect the outcome of the model.

The system may be configured to determine whether the user input data and/or population data meets one or more predefined satisfaction (e.g., completeness) criteria. For example, the system may require a threshold number of attributes in the individual characteristic data and/or population data to be described to execute the simulation model. For example, the system may require a minimum number of attributes (e.g., 3, 4, 5, or more attributes) describing the individual/household of interest and/or each individual/household within the population data. In some embodiments, in addition to or instead of a threshold number of attributes, the system may require specific attributes to be described in the individual characteristic data and/or in the population data to execute the simulation. For example, the system may require at least the age, occupation, and income of the individual/household of interest and/or each individual/household within the population data. In some embodiments, the system may require the attributes (e.g., age, income, occupation, etc.) to describe a threshold number of individuals/households in the population data. For example, the system may require the specified variables to describe at least 50%, 60%, 75%, or 95% of individuals/households in the population data. In the instance the satisfaction criteria are not fulfilled, at step 108, the system may generate synthetic data as an additional input for the agent-based simulation model. For example, the synthetic data may augment the existing individuals/households in the individual characteristic data and/or population data by describing the individuals/households with additional attributes. In some embodiments, the synthetic data may generate additional individuals/households based on the characteristic data describing the individual/household of interest and/or individuals/households in the population data. In some embodiments, the synthetic data may be generated using one or more proprietary synthetic dataset generation algorithms.

At step 110, based on the model inputs (e.g., individual and/or household characteristic data, population data, and optionally synthetic data) and socioeconomic and/or economic variables, the system may execute an agent-based simulation model. In some embodiments, the system may be configured to generate a digital twin, or “agent” of each individual/household based on the received individual/household characteristic data for the simulation model. For example, an agent may represent an individual and may be described by attributes from the received individual characteristic data and optionally synthetic data. Likewise, for each individual/household described by the population data and/or synthetic data, the system may be configured to generate an agent for use in the agent-based simulation model.

Each agent in the simulation model may be configured to interact with other agents based on the defined attributes associated with each of the agents and the socioeconomic and/or economic variables applied to the simulation. From the simulation, a financial portfolio (e.g., retirement readiness calculation) over time for the individual and/or household may be projected, as will be described in greater detail below. For example, the simulation may be used to determine (e.g., calculate) accumulation/decumulation and/or appreciation/depreciation of assets and liabilities of the individual at least for each year leading up to and beyond a target retirement age of the individual. In some embodiments, the simulation may be applied to project a financial portfolio of the individual and/or household over any chosen number of years. For example, the simulation may be used to project short-term/long-term savings goals.

Projecting the financial portfolio of an individual may comprise simulating the assets and liabilities over time for the individual, for example, on a daily, weekly, monthly, monthly, and/or yearly basis. In some embodiments, the financial portfolio may be simulated with a recurrence different from those provided above (e.g., bi-weekly, semi-annually, etc.). For example, the simulation may be configured to calculate and store the monthly income and expenses of the individual over a financial objective. For example, calculating monthly income may include determining pre-tax expenses (e.g., retirement product contributions) based on the user inputs, calculating taxes (e.g., based on one or more economic variables applied to the simulation), and determining post-tax income and post-tax expenses for the individual. In some embodiments, determining a monthly post-tax income may include calculating the income of the individual after tax, social security income, pension income (if applicable), and income from annuity and/or other financial products (e.g., investments, as will be described in greater detail below). The total monthly post-tax income for the individual may be aggregated by combining the above-mentioned income sources for the individual. In some embodiments, the total monthly post-tax income for the household including the individual may be determined by aggregating the calculated income data of the individuals in the household. The household and/or individual income may be determined for each future month and stored, for example, in a memory associated with the simulation model based on the above-mentioned calculations and assumptions.

As mentioned above, determining the overall monthly income may additionally include calculating post-tax expenses of the individual. The simulation may be configured to predict monthly expenses of the individual, for example, based on the characteristic data of the individual assigned to the agent and by observing the interaction of the individual with other agents in the simulation based on the model parameters (e.g., economic and/or socioeconomic variables). Monthly expenses may include, for example, credit card expenses, mortgage/rent expenses, student loan expenses, healthcare expenses, living expenses (e.g., food, clothing, gas, phone, insurance, etc.), and/or other fixed expenses. In some embodiments, one or more monthly expenses may be dependent on economic factors such as inflation and/or variability in income, which may be accounted for using one or more economic and/or socioeconomic variables. The system may be configured to aggregate the calculated expenses for the individual to produce a total post-tax expense for the individual. In some embodiments, the simulation model may be configured to determine the total post-tax expenses for the household of the individual, for example, by determining post-tax expenses for other individuals in the household and aggregating all expenses. In some embodiments, one or more expenses incurred by each individual in a household may be synthetically aggregated to determine the overall household expenses. The household and/or individual monthly expenses may be stored, for example, in a memory or a cache to enable parameterized calculation for next period of the specific calculation associated with the simulation model.

In some embodiments, determining monthly expenses may include determining expenses related to dependents in the household of the individual (if applicable). In some embodiments, the simulation model may be configured to predict the likelihood of the individual having children (e.g., regardless of whether the individual already has one or more children) and may predict the expenses associated with the children. For example, dependents (e.g., children) may cause the individual to incur additional monthly expenses such as healthcare expenses, education expenses (e.g., college tuition, student loans, etc.), additional credit card expenses, living expenses, etc. In some embodiments, expenses related to dependents may be applied to and split between individuals within a household to determine overall household income. Thus, the overall household income may be determined by aggregating the individual post-tax income of each individual in the household, as well as the various combined and/or individual post-tax expenses of the individuals in the household.

In some embodiments, the simulation may be configured to project the growth of a financial product (e.g., mutual funds, annuities, savings accounts, bonds, certificate of deposits, etc.) of the individual. In some embodiments, the simulation model may be configured to predict whether the individual will purchase a financial product in the simulated duration of time and may predict the performance of current and/or potential financial products of the individual, for example, based on the economic variables applied to the simulation model. For example, the return from a financial product may be based on the predicted monthly state of the economy. In some embodiments, the simulation may be configured to rebalance funds of the individual related to financial products for each simulated year. For example, the simulation model may be configured to determine percentage allocations for each asset class every year based on a rebalance strategy and may apply the percentage allocations to determine final fund balances for the year. In the instance the individual is in debt for mandatory expenses, the simulation may be configured to sell the assets that contribute the least appreciation to compensate for current downfall. In some embodiments, the simulation may also reinvest the same asset(s) during surplus in the later years. The system may be configured to store simulated monthly and yearly financial product data of the individual, which may be considered in projecting the financial portfolio of the user.

As mentioned above, the simulation may be configured to determine the retirement income for the individual and/or household. For example, determining the retirement income of the individual may include determining retirement assets and retirement expenses for each simulated year based at least on the above determined assets and liabilities as well as any additional expected appreciation or depreciation of retirement assets and expenses. In some embodiments, retirement assets may be based at least on social security income and the annuitized value of retirement savings (e.g., from 401(k) investments, IRAs, etc.). In some embodiments, retirement expenses may be based on an average expenditure style of the individual (e.g., projected based on input data) and expected average retirement expenses as a function of the final income of the individual. The retirement assets and expenses may be calculated, for example, on a yearly basis, and a projected yearly retirement readiness ratio may be outputted to the user of the system. The readiness ratio may be (or may include or may be based on) the ratio of total expected retirement assets to total expected retirement expenses projected. In some embodiments, the determined retirement readiness ratio value may also be classified, for example, as “overfunded,” “underfunded,” or “constrained.” For example, a ratio greater than or equal to 1.50 (e.g., 150%), for example, may be classified as “overfunded.” A ratio greater than or equal to 1.05 (e.g., 105%) but less than 1.50 may be classified as “constrained.” A ratio less than 1.05 may be classified as “underfunded.” In some embodiments, the classifications associated with the ratios may be different from the example values described above, as will be shown below with respect at least to FIG. 2A.

In some embodiments, executing the simulation model may comprise iterating through (e.g., running) the simulation multiple times (e.g., hundreds, thousands, millions of times, etc.) to determine a plurality of potential outcomes (e.g., projected incomes and expenses) that may be analyzed to determine the retirement readiness of the individual/household. For example, the system may be configured to identify median values and eliminate outliers and/or noise from the plurality of outcomes (e.g., for each year) to project a comprehensive financial portfolio (e.g., retirement readiness) of the individual and/or household.

At step 112, the system may output an initial output data, including for example projected financial portfolio of the individual and/or household. For example, the simulation may be configured to output a graphical representation (e.g., plot) on a graphical user interface illustrating the retirement readiness of the individual based on the projected assets and liabilities determined in the simulation. FIG. 2A illustrates an example retirement readiness output of an individual. The retirement readiness output 200a may comprise a plot of the projected retirement readiness ratio against time (e.g., each year). In some embodiments, as described above, the retirement readiness ratio may be classified as either overfunded, constrained (e.g., funded), or underfunded based on the ratio of retirement assets to expenses for each year, and the classifications may be illustrated in the output. For example, the plot may be segmented into horizontal portions corresponding to ranges of retirement readiness ratios, each range of ratios corresponding to a classification of retirement readiness. In FIG. 2A, a ratio less than or equal to about 0.75 (e.g., 75%) may be denoted as underfunded. A ratio between about 0.75 and 1.3 (e.g., 130%) may be denoted as funded. A ratio greater than or equal to 1.3 may be denoted as overfunded. Each yearly ratio may be a data point plotted on the graphical representation. In some embodiments, the data points may be visually connected to illustrate the overall growth and/or decline in assets/liabilities of the individual.

In some embodiments, the user may interact with the retirement readiness output 200a displayed on a graphical user interface by clicking/tapping one or more features on the plot to view additional information. For example, the user may click, tap, or hover over one or more features (e.g., data points) to view at least projected income and/or expense information considered in generating the retirement readiness ratio associated with the data point.

In some embodiments, in addition to and/or instead of a graphical representation, the simulation may be configured to output values, such as an overall net worth (e.g., assets less liabilities) of the individual and/or household at a target retirement age (or a range of ages proximate to a target retirement age). In some embodiments, the system may be configured to provide one or more recommendations based on the simulation results. For example, the system may display recommendations that may allow the individual to reach an appropriate retirement readiness ratio (e.g., classified as funded or overfunded, for example) by the target retirement age in the instance the current projection does not satisfy the individual's retirement goals. In some embodiments, the system may generate recommendations for potential areas the individual and/or household may consider allocating funds and/or saving to reduce expenses.

Returning to FIG. 1, at step 114, upon displaying an initial retirement readiness output, the system may additionally display one or more scenarios (e.g., life events) to the user, wherein the scenarios can be configured to “shock” the simulation model and modify the initial output provided by the simulation model. In some embodiments, the displayed scenarios may be suggested by the system based on actions of the user of the system (e.g., based on what the user clicked/tapped on in the user interface). In some embodiments, the displayed scenarios may be based on the provided characteristic data of the individual and/or household. For example, the system may be configured to suggest one or more scenarios based on a probability of the scenario occurring in the individual's lifetime. In some embodiments, the system may be configured to display a default set of scenario options regardless of the characteristics of the individual/household and/or usage trends of the user. In some embodiments, the scenario options may be a combination of any of the above-described scenario options.

As mentioned above, scenarios may include life events that an individual/household may not expect to occur and/or the simulation may not predict in their simulated lifetime. For example, scenarios may be systemic (e.g., affecting at least a subset of the population, wherein the subset may or may not include the individual and/or household) and/or personal (e.g., primarily affecting the individual/household). For example, systemic scenarios may include economic recessions, pandemics, natural disasters, wars, stock market impacts, etc. Personal scenarios may include early retirement, short-term disability, permanent disability, unemployment (e.g., laid off, sabbatical, prolonged leave, taking care of an ill relative, etc.), medical emergencies (e.g., related to the individual and/or one or more individuals (dependents, spouse) in the household), elderly care expenses, caregiver expenses, additional employment (e.g., getting an additional part-time job during full-time employment period, getting a part-time job during retirement period, etc.) and other unplanned expenses (e.g., vacations (during employment), marriage, large expenses such as vehicles, etc.). In some embodiments, personal scenarios may affect the household of the individual (e.g., the financial burden may be incurred by more than one individual, and thus split between individuals in the household). In some embodiments, scenario options may include the option to toggle factors affecting retirement, such as the existence of pension plans and/or social security benefits, and/or toggling retirement age. In some embodiments, the expense needed is withdrawn from several previous investments in the order that is suitable for the scenario or shock based on the expense amount, type, etc.

In some embodiments, the scenario options may be provided to the system user on a graphical user interface, for example, as selectable buttons and/or in a list format (e.g., drop-down menu, scrollable carousel-style list, list with checkboxes, etc.). In some embodiments, the user may select (e.g., click/tap) one or more scenarios to be applied in the simulation. In some embodiments, the user may select any number and/or combination of scenarios. In some embodiments, the user may specify whether the scenarios are to be applied to the simulation as a group, a combination of one or more selected scenarios, and/or individually. The system may receive the selected scenario(s) (e.g., as input from a user) at step 116.

In some embodiments, upon receiving one or more selected scenarios to be applied to the simulation, the system may update (e.g., add, augment, modify, and/or remove) one or more previously provided user inputs (e.g., characteristic data of the individual) at step 118 in FIG. 1. For example, upon receiving a selection of one or more scenarios, the system may be configured to prompt the user for one or more additional inputs based on the selection. For example, if the user has selected the scenario “early retirement,” the system may be configured to prompt the user for an age (or range of ages) that the individual would prefer to retire early at. In some embodiments, rather than requesting an age at which the scenario may be simulated, the system may be configured to randomly apply one or more selected scenarios (e.g., based on population data and/or synthetic data provided to the simulation) throughout the simulated lifetime of the individual. For example, if the user selects the scenario “unemployment” (e.g., for a sabbatical or in the instance the individual is currently not employed), but does not provide an age at which the sabbatical may occur for the individual, the system may be configured to predict when the sabbatical may occur in the simulation (e.g., based on user characteristic data and/or population data attributed to agents in the simulation). For example, population data may show that a majority of individuals who take a sabbatical take the sabbatical between 10 and 15 years after beginning employment with an employer, thus the simulation may be configured to simulate the sabbatical for the agent representative of the individual of interest based on this time range. As described herein, population data may comprise historic data, simulated/synthetic data, etc.

In some embodiments, the user may provide a range of values corresponding with one or more scenario selections. For example, the user may select the scenario “unemployment” and may further specify a range of time for the length of unemployment and/or a range of ages at which the unemployment may occur in the individual's life. In some embodiments, the simulation may be configured to predict when unemployment may be most probable in the individual's life, for example, based on characteristic data of the individual and/or socioeconomic/economic variables of the model. In some embodiments, the simulation may be configured to simulate a period of unemployment for a predefined amount of time, for example, based on population data. For example, the population data may inform an average duration of time spent unemployed across individuals in the population data (e.g., 24 weeks or less), and the model may be configured to simulate unemployment for a duration of time within the predefined amount of time.

In some embodiments, the user may select the scenario “short-term disability,” and the system may be configured to request additional information from the user related to the age (or range of ages) at which the short-term disability occurred previously or may occur in the future, length of time of the disability, and insurance coverage of the individual. In some embodiments, one or more inputs may be randomized and/or set to a default input value (e.g., based on population data) if a corresponding user input is not received. For example, the simulation may be configured to predict insurance coverage, most probable age of disability, and/or duration of disability of an individual based on occupation data of the individual and/or related population data. For example, the simulation may identify trends related to short-term disabilities (and/or other scenarios) in the population and/or synthetic dataset, the trends related to attributes such as age, geographical location, gender, occupation, etc. and may predict the effect of a short-term disability on the individual based on commonly identified attributes with the data.

In some embodiments, the user may select a scenario that may be associated with a variable monetary value (e.g., unexpected expenses, such as additional vehicles, marriage, etc.). The system may be configured to request additional user inputs to fulfill the required inputs for running the simulation based on the selected scenario. In some embodiments, rather than requiring the user to provide inputs, the system may be configured to estimate expense amounts (e.g., based on characteristic user data, population data, etc.). For example, the user may select “unexpected expense—additional vehicle” and may input an estimate cost of the vehicle. In some embodiments, the user may not input an estimate cost of the vehicle, and rather, the system may be configured to predict the cost of the vehicle (e.g., based on characteristic data, such as income, of the individual).

In some embodiments, the user may select the additional inputs that refine a given scenario from a pre-populated selection, and/or may manually input one or more additional inputs based on a prompt provided by the system. For example, the system may request an age and/or range of ages for early retirement, and the user may select from a predetermined selection of ages (e.g., displayed in a list, timeline, a carousel, buttons, etc.). In some embodiments, the user may manually input an age and/or range of ages. In some embodiments, the user may be presented with a “no preference” option for refining one or more selected scenarios and may select this option to cause the system to randomly generate an occurrence (e.g., duration of time, age, etc.) at which a scenario may occur in the simulated lifetime of the individual.

Prior to executing the simulation with the one or more selected scenarios, the system may be configured to again verify whether the input data (e.g., pre-existing individual/household characteristic data, population data, synthetic data, etc.) is sufficient for the simulation. The system may verify the inputs in a similar manner as was previously described above with respect to step 106. In some embodiments, the system may be configured to generate synthetic data for running the simulation with one or more selected scenarios based on a determination that the received input data is not sufficient for the simulation (step 108). In some embodiments, the system may be configured to generate and/or update one or more agents in the simulation based on the augmented input data. In some embodiments, updating one or more agents may include appending additional attributes to and/or updating existing attributes associated with the agents.

Based on at least the updated inputs, the system may be configured to execute the simulation with the one or more selected scenarios (step 110). As mentioned above, in some embodiments, the simulation may be executed for each selected scenario individually and/or as a group and/or combination of scenarios. In some embodiments, executing the simulation with the scenarios may comprise iterating the simulation multiple times (e.g., hundreds, thousands, millions of times, etc.) to determine a plurality of potential outcomes (e.g., projected incomes and expenses) based on the scenarios that may be analyzed to determine an updated retirement readiness of the individual/household. The system may be configured to identify median values and eliminate outliers and/or noise in the plurality of outcomes (e.g., for each year) to project a comprehensive financial portfolio (e.g., retirement readiness) of the individual and/or household considering the one or more selected scenarios. The updated retirement readiness produced from the simulation may be displayed in a similar manner as described above with respect to step 112. For example, the results may be displayed on a graphical user interface in a visualization (e.g., graphical representation, plot, etc.). Example outputs will be described in greater detail below with respect to FIGS. 2B-2G.

The steps of selecting one or more scenarios, updating the model inputs, and executing the simulation may be iterated an any number of times based on the preference of the user. For example, the user may select and/or deselect one or more scenarios and re-execute the simulation with the new combination of scenarios any number of times to determine how the financial portfolio (e.g., retirement readiness) of the individual and/or household is affected by different individual and/or combinations of scenarios. After each execution of the simulation, at step 112, an updated retirement readiness result for the individual/household may be displayed to the user.

### Example Scenarios of Simulation-Based Modeling System

As mentioned above, scenarios that may be selected by the user of the simulation-based modeling system may be systemic and/or personal scenarios. The system may be configured to demonstrate the impact of these scenarios (e.g., life events or financial “shocks”) on an individual and/or household's retirement readiness. For example, different scenarios may affect different assets of the individual/household differently, and the simulation may be configured to show how the financial portfolio of the individual reacts to adversity introduced from the selected scenarios.

As mentioned above, a variety of scenario options may be presented to the user. For example, scenarios may include introducing a flexible retirement age, short-term disability, permanent disability, unemployment, unexpected medical emergency, economic recession, and/or unplanned costs (e.g., vacation, vehicle purchases, etc.). Each of these examples will be described in greater detail below.

In some embodiments, a user of the simulation model may be interested in determining how the financial portfolio of a household may be affected by early retirement of an individual in the household. For example, the simulation system may be configured to receive user inputs comprising one or more desired ages at which the individual is interested in retiring early at. The simulation may be configured to be executed with the early retirement age applied to the agent representative of the individual. In some embodiments, the simulation may be executed for a range of early retirement ages, and each retirement readiness output may be displayed overlaid on a graphical representation to allow a user to visualize how the retirement readiness of the household is affected by different retirement ages. In some embodiments, the system may be configured to simulate how the retirement readiness of an individual may be affected if the individual was to prolong joining the workforce, and/or if the individual re-joined the workforce during retirement (e.g., through obtaining a part-time job).

In some embodiments, a user of the simulation model may be interested in determining how the financial portfolio of a household may be affected by one or more individuals in the household experiencing a short-term disability. For example, the simulation may be configured to simulate a leave of absence due to a health condition an individual for a duration of time (e.g., 3 months) due to a short-term disability. Based on the simulation results, the system may output how the disability may affect the short-term and/or long-term retirement planning goals of the household.

In some embodiments, a user of the simulation model may be interested in determining how the financial portfolio of a household may be affected by one or more individuals experiencing a permanent disability. For example, an individual may experience a permanent disability that may prolong their return to the workforce for a duration of time, indefinitely, or permanently. In some embodiments, the individual may experience a permanent disability that may allow them to return to the workforce after a duration of time, however, may require the individual to change employment (e.g., change occupation, change to part-time work, etc.). The simulation may be used to predict how the disability may affect the retirement readiness of the household of the individual. In some embodiments, the simulation may be applied to determine when the individual should return to work to stay on track with their retirement goals. In some embodiments, the simulation may be used to determine if and/or when the individual should return to work, and/or a duration of time the individual should return to work for, e.g., to meet retirement goals.

In some embodiments, a user of the simulation model may be interested in determining how the financial portfolio of a household may be affected by one or more individuals experiencing unemployment for a duration of time. For example, an individual may consider being unemployed to be a caregiver for their children for an additional amount of time (e.g., 3 years). The simulation may be used to determine whether the current assets of the individual will be sufficient for the individual to be unemployed for the desired amount of time. In some embodiments, the system may be applied to simulate unemployment due to unexpected layoffs (e.g., due to poor economic conditions). The simulation may be configured to determine whether an individual will be sufficient with their current assets while searching for a new job.

In some embodiments, a user of the simulation model may be interested in determining how the financial portfolio of a household may be affected by one or individuals experiencing an unexpected medical emergency. For example, an individual may work in an accident-prone job where the employer will cover at least a portion of costs if an accident were to occur. The simulation may be configured to determine how the financial portfolio of the individual/household may be affected by a medical emergency (e.g., with/without a portion of the cost being covered by an employer and/or insurance).

In some embodiments, a user of the simulation model may be interested in determining how the financial portfolio of a household may be affected by a systemic scenario, such as an economic recession. Economic recessions are often unforeseen; thus, the simulation may be used to predict how a recession would affect not only the individual and/or household, but also additional agents in the simulation. Simulating an economic recession may be based on historic population data related to past economic recessions. In some embodiments, factors related to the simulated recession, such as duration of the recession and magnitude of the recession may be customized. For example, in the instance the individual falls within an economic class more prone to being affected by a recession, the individual can use the simulation to determine how their financial portfolio would be affected.

In some embodiments, a user of the simulation model may be interested in determining how the financial portfolio of a household may be affected by unexpected costs. For example, an individual may be interested in buying a new car in the future and may execute the simulation to determine how this large purchase may affect their financial assets over time. In another example, the individual may be interested in taking a large trip with family after retirement and may use the simulation to determine whether their predicted retirement assets will allow them to fund the trip.

### Example Outputs of Simulation-Based Modeling System

The simulation-based modeling system may be configured to provide time series outputs to the user of the system, for example, in the form of visualizations (e.g., graphical representations, such as plots), recommendations, values, etc. on a display (e.g., graphical user interface).

FIGS. 2A-2G illustrate example retirement readiness outputs of the simulation-based modeling system. As shown in each of the Figures, the time series outputs may span from the current year/month for a number of years that can be based on user selection, the average life expectancy, etc. as determined by the system. As described above, FIG. 2A shows an example initial retirement readiness output 200a of the simulation prior to applying one or more scenarios (e.g., life events) to the system. FIGS. 2B-2G show example updated retirement readiness outputs based on one or more selected scenarios being incorporated to the simulation, each of which will be described in greater detail below.

FIG. 2B shows an example retirement readiness output 200b of the simulation-based modeling system, in accordance with some embodiments. For example, the output may demonstrate the effect of various scenarios, such as short-term disability, long-term disability, unemployment, and unexpected expenditure (e.g., purchase) on an individual's retirement readiness at a given retirement age (e.g., 65). As shown, in some embodiments, each of the selected scenarios may be overlaid on a single plot. In some embodiments, the selected scenarios may be displayed graphically on individual plots. In some embodiments, the plot may comprise a legend to differentiate the scenarios (e.g., each data point and/or line on the plot may be colored, and the color may correspond with a scenario as depicted in the legend). The plot may demonstrate yearly retirement readiness as a mean value (e.g., described above, based on the outputs from executing the simulation multiple times). As described above, retirement readiness may be estimated for each year as a ratio of estimated retirement assets against estimated retirement expenses. From analyzing the example retirement readiness output 200b, the user may conclude at least that the cost associated with a short-term disability may have a minimal effect on retirement readiness of the individual, whereas a permanent disability may have a large effect on retirement readiness. Furthermore, the user may observe that an unexpected purchase may cause a sudden drop in the year of the purchase, and a lower peak in retirement readiness at the desired age of retirement. Finally, the user may determine that facing unemployment early in the career of the individual may lead to a short-term decrease in readiness at least because unemployment may cause a reduction in assets.

FIG. 2C shows an example retirement readiness output 200c of the simulation-based modeling system, in accordance with some embodiments. Like output 200b shown in FIG. 2B, the output may comprise a visualization of the retirement readiness of an individual/household based on numerous selected scenarios. For example, scenarios may include unexpected purchases of various monetary values (e.g., for a vacation) in a selected year (e.g., year 2045) and unemployment (e.g., at age 33). In some embodiments, the selected scenarios may be compared to the projected retirement readiness with no scenarios applied to the simulation. From analyzing the example retirement readiness output 200c, the user may visualize a decrease in retirement readiness during the time of unemployment, which may affect the ability of the household to afford a vacation in the future. In addition, the user may visualize a rapid decrease in retirement readiness due to a costly vacation. As shown, the user may use the simulation to determine an amount of money to budget towards a vacation by comparing potential vacation costs in a given simulated year.

FIGS. 2D and 2E show an example retirement readiness output 200d and example retirement asset output 202e, respectively, in accordance with some embodiments. For example, FIG. 2D may illustrate the effect of retirement age on retirement readiness by displaying the retirement readiness based on a default retirement age (e.g., 65) as well as a plurality of additional retirement ages. As mentioned above, in some embodiments, the retirement ages may be based on a user selection. In some embodiments, the system may be configured to perform simulations with randomized retirement ages (e.g., based on common retirement ages found in population data). For example, the retirement readiness output 200d in FIG. 2D shows retirement readiness with a retirement age of 50, 60, and 70, however, any age may be selected by the user for the simulation. The user may conclude that retirement readiness increases with an increase in retirement age, at least because the individual may have higher assets at a higher age. The user may determine that the individual may have the ability to retire before the default retirement age of 65 based on the retirement readiness output 200d (e.g., at the age of 60) and still be overfunded for several years after retirement.

In some embodiments, in addition to or in place of a graphical representation of retirement readiness over time, the system may be configured to produce a visualization of expected retirement assets over time, as shown in FIG. 2E. In some embodiments, the retirement assets output 202e may comprise plots of retirement assets based on different selected scenarios. For example, the selected scenarios may correspond to those described above with respect to FIG. 2D. Thus, retirement asset output 202e may allow the user to visualize the effect of retirement age on the growth of retirement assets over time.

FIGS. 2F and 2G show an example retirement readiness output 200f and example retirement asset output 202g, respectively, in accordance with some embodiments. For example, FIG. 2F may illustrate the effect of disability scenarios (e.g., short-term and/or permanent disabilities) on retirement readiness. As mentioned above, in some embodiments, the system may require insurance coverage information for simulating a disability of an individual. Without insurance information from the user, the system may be configured to predict insurance coverage of the individual. As shown in FIG. 2F, the user may choose to simulate the occurrence of a short-term and/or permanent disability with and without insurance. For example, retirement readiness output 200f shows the effect of a short-term disability with insurance at age 50, a short-term disability without insurance at age 50, a permanent disability at age 50, and no scenario. From the output 200f, the user may conclude for the individual that a short-term disability does not significantly impact retirement readiness, whereas a permanent disability may affect retirement readiness. However, due to at least partial insurance coverage, the user may conclude that the household may not be underfunded for retirement despite the disability.

In some embodiments, in addition to or in place of a graphical representation of retirement readiness over time, the system may be configured to produce a visualization of expected retirement assets over time, as shown in FIG. 2G. In some embodiments, the retirement assets output 202g may comprise plots of retirement assets based on different selected scenarios. For example, the selected scenarios may correspond to those described above with respect to FIG. 2F. Thus, retirement asset output 202g may allow the user to visualize the effect of an individual experiencing a disability on the growth of retirement assets over time.

### Method for Determining Retirement Readiness

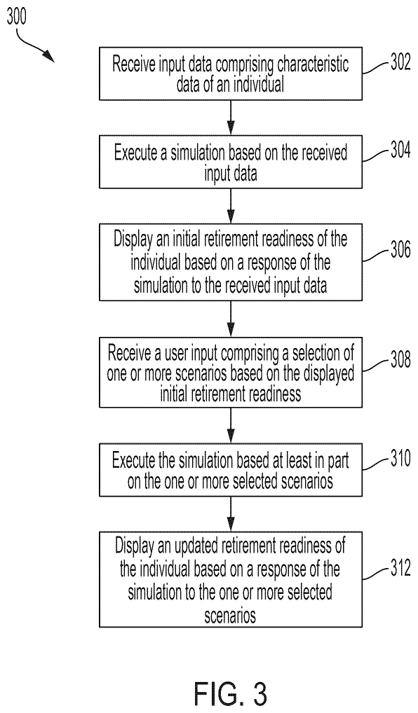

FIG. 3 shows a method 300 for determining retirement readiness of an individual, in accordance with some embodiments. In some embodiments, method 300 may be integrated to a computerized system. In some embodiments, one or more blocks in method 300 may correspond to one or more steps in process diagram 100 shown in FIG. 1.

At block 302, the system may be configured to receive input data comprising characteristic data of an individual. In some embodiments, input data may comprise characteristic data of a more than one individual, such as members of a household (e.g., spouses, partners, etc.). In some embodiments, characteristic data may include financial data, household data, and/or socioeconomic data.

At block 304, the system may be configured to execute a simulation based on the received input data. In some embodiments, the simulation may be executed using population data (e.g., characteristic data describing a population) and/or synthetically generated data in addition to the individual characteristic data. In some embodiments, the system may be configured to generate current and/or predict future socioeconomic and/or economic variables for the simulation.

At block 306, the system may be configured to display an initial retirement readiness of the individual based on the response of the simulation to the received input data. For example, the initial retirement readiness may be displayed in a visualization including a graphical representation of the initial retirement readiness over a passage of time. In some embodiments, the system may be configured to provide a recommendation to the user in addition to or instead of the visualization.

At block 308, the system may be configured to receive a user input comprising a selection of one or more scenarios, the scenarios selected based on the displayed initial retirement readiness. For example, the system may be configured to display a plurality of scenario options to the user, concurrently with and/or after the initial retirement readiness visualization. The scenario options may be based on one or more of actions of the system user, the individual characteristic data, and/or the population data. For example, the population data may be used to generate agents in the simulation, and the displayed systemic scenario options may be based on attribute data of the agents. In some embodiments, one or more of the displayed scenarios may be personal scenarios generated based on characteristic data of the individual.

At block 310, the system may be configured to execute the simulation based at least in part on the one or more selected scenarios. In some embodiments, prior to executing the simulation, the system may be configured to update model inputs based on the one or more selected scenarios. In some embodiments, the system may be configured to receive additional input data based on the one or more selected scenarios. In some embodiments, executing the simulation may comprise running the simulation a plurality of times (e.g., hundreds, thousands, millions, etc.). In some embodiments, executing the simulation may additionally comprise analyzing the potential outcomes produced from the iterations of the simulation to determine a retirement readiness output.

At block 312, the system may be configured to display an updated retirement readiness of the individual based on the response of the simulation to the one or more selected scenarios. In some embodiments, the updated retirement readiness may be displayed in a visualization. In some embodiments, the visualization may additionally include the initial retirement readiness. In some embodiments, the initial retirement readiness and updated retirement readiness may be displayed in individual visualizations. In some embodiments, the visualization may comprise a graphical representation of retirement readiness. In some embodiments, the visualization of updated retirement readiness may comprise a plurality of graphical representations, wherein each graphical representation corresponds to a selected scenario. In some embodiments, a given graphical representation may correspond to a combination of selected scenarios. In some embodiments, the graphical representations may comprise a plurality of data points that may correspond to retirement readiness values over a duration of time.

### Simulation-Based Modeling Systems & Devices

As mentioned above process 100 described above with respect to FIG. 1 and/or method 300 described with respect to FIG. 3 may be implemented in a computerized system to project the financial portfolio (e.g., determine retirement readiness) of an individual.

FIG. 4 shows a system 400 comprising a simulation model engine for determining retirement readiness, in accordance with some embodiments. Simulation model engine 402 may be configured to receive user inputs 406 and execute a simulation to generate outputs 408 based on the inputs 406 and received population data 410. As mentioned above with respect to FIG. 1, population data 410 may be accessed from one or proprietary and/or public datasets. For example, population data 410 may be stored in a memory associated with simulation model engine 402. In some embodiments, population data 410 may include data used to calibrate the simulation model engine, as described herein.

In some embodiments, simulation model engine 402 may comprise a microservice architecture with a plurality of microservices 404, each microservice configured to provide a service for simulation model engine 402. For example, simulation model engine 402 may comprise one or more microservice frameworks developed in various programming languages (e.g., Java, NodeJS, etc.). For example, the system may comprise a Spring Boot framework (e.g., developed using Java programming language) for the simulation. In some embodiments, the simulation model engine 402 may additionally comprise a Kubernetes architecture configured to compose, scale, deploy, and/or manage one or more components in the system.

Each microservice of simulation model engine may be individually deployable, and may communicate with another (e.g., via one or more servers). In some embodiments, one or more microservices may comprise a set of microservices. Microservices may allow for packaging code, parallel processing, efficient central processing unit (CPU) memory usage, seamless integration, and computational elasticity. Furthermore, microservices may allow the simulation model to be easily scalable and used by a large number (e.g., thousands) of users at one time.

A user may provide user inputs 406 via a user interface associated with a client device. The client may pass a request to a server (e.g., identity provider) that may authenticate client requests and communicate the requests to an application programming interface (API) gateway. The API gateway may act as the entry point for the clients to forward requests to the appropriate microservices within simulation model engine 402. In some embodiments, the API gateway can perform cross-cutting functions, such as providing security, load balancing, etc.

After receiving requests from a client device based on user inputs 406, the microservices of simulation model engine 402 may communicate with one another to handle the client requests. For example, the microservices may communicate via synchronous and/or asynchronous messages. In some embodiments, each microservice may comprise a private database configured to capture their data and implement the respective functionality. The services from each microservice may be carried forward to a remote service of simulation model engine 402 which allows for inter-process communication. The produced static content from the microservices may be deployed to a cloud-based storage service (e.g., POSTGRES database) that may be configured to deliver content (e.g., model output 408) back to the client (e.g., via content delivery networks, CDNs).

FIG. 4 moreover illustrates the complex relationships between microservices, agents, and other dynamics, functions, and variables of the system 400. For example, each of the microservices 404 may be leveraged by one or more agents 412 of simulation model engine 402. Moreover, each of the agents 402 may be governed by varying dynamics, functions, and variables defined by the system 400. For example, one or more agents 412 may be configured to execute a function to calculate one or more metrics utilized by the model to determine the output. In some embodiments, one or more agents may execute dynamics (e.g., shocks/life events) for a similar reason. In doing so, the agents 412 may utilize variables defined within the system. The model output 408 provided based on the interactions between agents in the system may comprise a time series projection/simulation, as described herein.

Simulation model engine 402 may comprise additional components not illustrated in FIG. 4. For example, the engine may comprise a management component configured to balance services on nodes and identify failures in the microservice architecture. The engine may additionally comprise a service discovery component that may serve as a guide to the microservices of simulation model engine 402 for routes of communication in the architecture by maintaining a list of services on which nodes are located.

FIG. 5 illustrates an example of a computing system 500, in accordance with some examples of the disclosure. System 500 can be a client or a server. As shown in FIG. 5, system 500 can be any suitable type of processor-based system, such as a personal computer, workstation, server, handheld computing device (portable electronic device) such as a phone or tablet, or dedicated device. The system 500 can include, for example, one or more of input device 520, output device 530, one or more processors 510, storage 540, and communication device 560. Input device 520 and output device 530 can generally correspond to those described above and can either be connectable or integrated with the computer.

Input device 520 can be any suitable device that provides input, such as a touch screen, keyboard or keypad, mouse, gesture recognition component of a virtual/augmented reality system, or voice-recognition device. Output device 530 can be or include any suitable device that provides output, such as a display, touch screen, haptics device, virtual/augmented reality display, or speaker.

Storage 540 can be any suitable device that provides storage, such as an electrical, magnetic, or optical memory including a RAM, cache, hard drive, removable storage disk, or other non-transitory computer readable medium. Communication device 560 can include any suitable device capable of transmitting and receiving signals over a network, such as a network interface chip or device. The components of the computing system 500 can be connected in any suitable manner, such as via a physical bus or wirelessly.

Processor(s) 510 can be any suitable processor or combination of processors, including any of, or any combination of, a central processing unit (CPU), field programmable gate array (FPGA), and application-specific integrated circuit (ASIC). Software 550, which can be stored in storage 540 and executed by one or more processors 510, can include, for example, the programming that embodies the functionality or portions of the functionality of the present disclosure (e.g., as embodied in the devices as described above)

Software 550 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 540, that can contain or store programming for use by or in connection with an instruction execution system, apparatus, or device.

Software 550 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport computer readable medium can include, but is not limited to, an electronic, magnetic, optical, electromagnetic, or infrared wired or wireless propagation medium.

System 500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

System 500 can implement any operating system suitable for operating on the network. Software 550 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The present disclosure in some embodiments relates to a device for performing the operations herein. This device may be specially constructed for the required purposes, or it may comprise a general purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present disclosure as described herein.

In the foregoing description of the various embodiments, it is to be understood that the singular forms “a,” “an,” and “the” used in the foregoing description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated. For the purpose of clarity and a concise description, features are described herein as part of the same or separate embodiments; however, it will be appreciated that the scope of the disclosure includes embodiments having combinations of all or some of the features described.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A simulation system for determining retirement readiness, comprising:
one or more processors; memory; and one or more programs stored on the memory that when executed by the one or more processors cause the one or more processors to:
receive input data comprising characteristic data of an individual;
execute a simulation based on the received input data;
display, based on a response of the simulation to the received input data, an initial retirement readiness of the individual;
receive a user input comprising a selection of one or more scenarios based on the displayed initial retirement readiness;
execute the simulation based at least in part on the one or more selected scenarios; and
display, based on a response of the simulation to the one or more selected scenarios, an updated retirement readiness of the individual.

2. The simulation system of claim 1, wherein the initial retirement readiness and the updated retirement readiness of the individual are displayed in at least one visualization.

3. The simulation system of claim 2, wherein the initial retirement readiness is displayed in a first visualization, and the updated retirement readiness is displayed in a second visualization.

4. The simulation system of claim 2, wherein the visualization of the updated retirement readiness comprises one or more graphical representations corresponding to the one or more selected scenarios.

5. The simulation system of claim 4, wherein a graphical representation in the visualization of the updated retirement readiness corresponds to a combination of selected scenarios.

6. The simulation system of claim 4, wherein the one or more graphical representations comprise a plurality of data points corresponding to retirement readiness values over a duration of time.

7. The simulation system of claim 1, comprising receiving additional input data comprising characteristic data of the individual based on the selection of one or more scenarios.

8. The simulation system of claim 7, wherein the simulation is executed based on the one or more selected scenarios and the additional input data.

9. The simulation system of claim 1, comprising displaying a plurality of scenario options with the initial retirement readiness of the individual.

10. The simulation system of claim 9, wherein one or more of the displayed scenario options are based at least in part on actions of a user of the simulation system.

11. The simulation system of claim 9, wherein one or more of the displayed scenario options are personal scenarios based at least in part on the characteristic data of the individual.

12. The simulation system of claim 1, wherein the simulation comprises a plurality of agents generated based on characteristic data of a population.

13. The simulation system of claim 12, comprising displaying one or more systemic scenario options based at least in part on the characteristic data of the population.

14. The simulation system of claim 1, comprising displaying a recommendation based on the updated retirement readiness of the individual.

15. The simulation system of claim 1, wherein the characteristic data of the individual comprises one or more of socioeconomic data, household data, and financial data.

16. The simulation system of claim 1, wherein executing the simulation based at least in part on the one or more selected scenarios comprises running a plurality of iterations of the simulation.

17. The simulation system of claim 16, wherein executing the simulation based at least in part on the one or more selected scenarios comprises analyzing potential outcomes of the plurality of iterations to determine a retirement readiness output.

18. The simulation system of claim 17, wherein the retirement readiness output corresponds to the updated retirement readiness of the individual at a given time.

19. A method for determining retirement readiness, the method comprising:
receiving input data comprising characteristic data of an individual;
executing a simulation based on the received input data;
displaying, based on a response of the simulation to the received input data, an initial retirement readiness of the individual;
receiving a user input comprising a selection of one or more scenarios based on the displayed initial retirement readiness;
executing the simulation based at least in part on the one or more selected scenarios; and
displaying, based on a response of the simulation to the one or more selected scenarios, an updated retirement readiness of the individual.

20. A non-transitory computer-readable storage medium storing one or more programs for determining retirement readiness, the programs for execution by one or more processors of an electronic device that when executed by the device, cause the device to:
receive input data comprising characteristic data of an individual;
execute a simulation based on the received input data;
display, based on a response of the simulation to the received input data, an initial retirement readiness of the individual;
receive a user input comprising a selection of one or more scenarios based on the displayed initial retirement readiness;
execute the simulation based at least in part on the one or more selected scenarios; and
display, based on a response of the simulation to the one or more selected scenarios, an updated retirement readiness of the individual.
